(19) United States
(12) Patent Application Publication
(10) Pub. No.: US 2024/0428120 A1
(43) Pub. Date: Dec. 26, 2024

(54) COGNITIVE FRAMEWORK FOR NON-FUNCTIONAL REQUIREMENT BASED TECHNICAL DISPOSITION

(71) Applicant: International Business Machines Corporation, Armonk, NY (US)

(72) Inventors: Anil Paingankar, Bangalore (IN); Rajesh Kumar Saxena, Thane East (IN); Harish Bharti, Pune (IN); Sandeep Sukhija, Rajasthan (IN)

(21) Appl. No.: 18/214,406

(22) Filed: Jun. 26, 2023

(51) Int. Cl. G06N 20/00

(52) U.S. Cl. CPC G06N 20/00

(57) ABSTRACT

A method of using a computing device to provide non-functional requirement (NFR) fulfilment based technical disposition including identifying, by the computing device, optimal solutions based on overlaying prioritized NFRs for at least one target system as supported by each candidate system of multiple candidate systems. Supportable technical NFRs are used for each combination of options under the multiple candidate systems. Identifying further includes generating a cognitive processing model using machine learning adaptability for extracting NFRs for options for existing system designs. Classification overlay of each individual candidate system is provided across the NFRs prioritized based on business requirement. Unbiased decision processing utilized based on discord, exclusion and similarity as functions of the cognitive processing model. A sub-optimal solution space and adaptability for the sub-optimal solution space in absence of an optimal solution is identified.

### BACKGROUND

The field of embodiments of the present invention relates to non-functional requirement (NFR) fulfilment based technical disposition.

A cognitive enterprise needs to adapt multiple new and emerging concepts quickly to sustain and lead the market, such as cloud, intelligent workflow, robotics, artificial intelligence/machine learning (AI/ML), data and domain-driven approach. To strategize and build a cognitive enterprise, it is necessary to align all the resources and assets considering not only the business requirement but also, non-business requirements (non-functional requirements (NFRs)). The challenge is the diverse, heterogenous environment that the assessment needs to be executed to validate these NFRs every time there is a change or a new requirement. It becomes very important to align the system with enterprise strategy and select options available with enterprise strategy that fulfills the business prioritized NFRs. The current era of hybrid-multi-cloud hosting technology gets upgraded at short notice. One of the examples will be a cloud fabric integrating software as a system (SaaS), platform as a service (PaaS) and on-premise (on-prem) systems. Any change to either of the service providers impacts the overall system. It is critical for impacted systems to be adaptive resulting in alignment with NFRs for a set of timelines of selecting the available options within the technology strategy. Business outcome is faster due to adaptability to changes from the ecosystem players, thereby reducing the regulatory and revenue impact.

### SUMMARY

Embodiments relate to non-functional requirement (NFR) fulfilment based technical disposition. One embodiment provides a method of using a computing device to provide NFR fulfilment based technical disposition including identifying, by the computing device, optimal solutions based on overlaying prioritized NFRs for at least one target system as supported by each candidate system of multiple candidate systems. Supportable technical NFRs are used for each combination of options under the multiple candidate systems. Identifying further includes generating a cognitive processing model using machine learning adaptability for extracting NFRs for options for existing system designs. Classification overlay of each individual candidate system is provided across the NFRs prioritized based on business requirement. Unbiased decision processing utilized based on discord, exclusion and similarity as functions of the cognitive processing model. A sub-optimal solution space and adaptability for the sub-optimal solution space in absence of an optimal solution is identified.

These and other features, aspects and advantages of the present embodiments will become understood with reference to the following description, appended claims and accompanying figures.

### BRIEF DESCRIPTION OF THE DRAWINGS

FIG. 1 illustrates a flow diagram for non-functional requirement (NFR) fulfilment based technical disposition and recommendation, according to one embodiment;

FIG. 2 illustrates example NFR classifications that are business configured based on use-case specific requirements, according to one embodiment;

FIG. 3 illustrates example weightage defined by business as a classification system with grading for the target system, according to one embodiment;

FIG. 4 illustrates an example of business defined NFRs for a target system with desired classification, according to one embodiment;

FIG. 5 illustrates an example of NFR classification for two systems each ranked against seven categories of NFR fulfilment for the combination of such attributes into heterogeneous links (System 1, System 2, System N) decided through an overall classification decision function, according to one embodiment;

FIG. 6 illustrates a graph of a desired system and candidate systems versus NFRs, according to an embodiment;

FIG. 7 illustrates a process for providing NFR fulfilment based technical disposition, according to an embodiment; and

FIG. 8 illustrates an example computing environment utilized by one or more embodiments.

### DETAILED DESCRIPTION

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments relate to non-functional requirement (NFR) fulfilment based technical disposition. One embodiment provides a method of using a computing device to provide NFR fulfilment based technical disposition including identifying, by the computing device, optimal solutions based on overlaying prioritized NFRs for at least one target system as supported by each candidate system of multiple candidate systems. Supportable technical NFRs are used for each combination of options under the multiple candidate systems. Identifying further includes generating a cognitive processing model using machine learning adaptability for extracting NFRs for options for existing system designs. Classification overlay of each individual candidate system is provided across the NFRs prioritized based on business requirement. Unbiased decision processing utilized based on discord, exclusion and similarity as functions of the cognitive processing model. A sub-optimal solution space and adaptability for the sub-optimal solution space in absence of an optimal solution is identified.

The task of performing the alignment of strategic options with NFRs, and then to identify the best fit system challenges to meet high-quality decision making in a shorter time frame. To derive an accurate and precise evolving technology roadmap it is important to consider NFR fulfillment with an ongoing technology disposition progressively. In one embodiment, a reliable, and high performing orchestration system identifies the optimal and alternate sub-optimal systems that satisfy NFRs. One or more embodiments build a cognitive engine that powers a cognitive framework based on artificial intelligence (AI) with machine learning (ML) capability to identify the optimal and sub-optimal systems considering the fulfillment of these technical NFRs.

One or more embodiments provide identification of optimal solutions by overlaying the business prioritized NFRs for target system(s) as supported by each candidate system. Further, the embodiments provide identification and adaptability of sub-optimal solution space excluding or in absence of an optimal solution. One or more embodiments take into consideration of supportable technical NFRs for each combination of options under various system. ML adaptability is provided to extract NFRs for options considered for existing system designs. The embodiments accurately provide what the classification overlay is of each individual system across the NFRs prioritized by the business. The embodiments use unbiased decision processing with the help of discord, exclusion and similarity as model-functions.

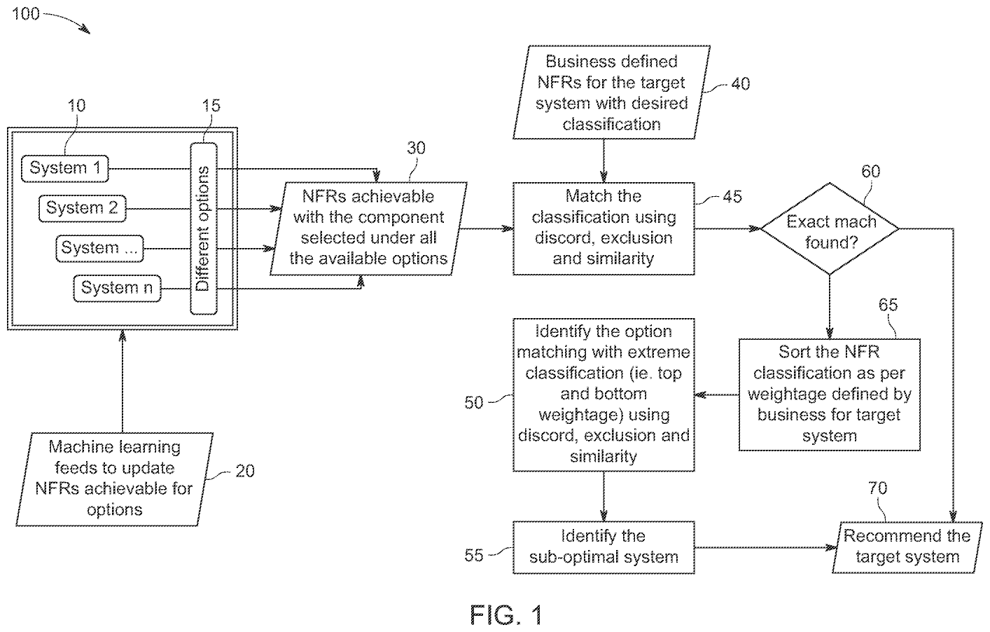

FIG. 1 illustrates a flow diagram 100 for NFR fulfilment based technical disposition and recommendation, according to one embodiment. In one embodiment, in block 10, multiple systems 1-n receive ML feeds to update NFRs achievable for options 20. One or more embodiments include a model for processing that employs one or more AI models. AI models may include a trained ML model (e.g., models, such as a neural network (NN), a convolutional NN (CNN), a recurrent NN (RNN), a Long short-term memory (LSTM) based NN, gate recurrent unit (GRU) based RNN, tree-based CNN, a self-attention network (e.g., a NN that utilizes the attention mechanism as the basic building block; self-attention networks have been shown to be effective for sequence modeling tasks, while having no recurrence or convolutions), BILSTM (bi-directional LSTM), etc.). An artificial NN is an interconnected group of nodes or neurons.

The systems 1-n in block 10 aggregate the different options 15. In block 30, NFRs achievable with the component selected under all the available options is determined. In block 45, the output of block 30 are received as input as well as business defined NFRs for the target system with the desired classification from block 40. Block 45 matches the classification using discord, exclusion and similarity. In block 60 it is determined whether an exact classification match is found or not. If a classification match is found, in block 65 the NFR classification is sorted as per weightage defined by business for the target system. Otherwise, the flow proceeds to block 70 described below. After block 65 processing is completed, in block 50 the option matching with extreme classification (i.e., top and bottom weightage) is identified using discord, exclusion and similarity. In block 55 the sub-optimal system is identified. In block 70, the target system is provided as a recommendation.

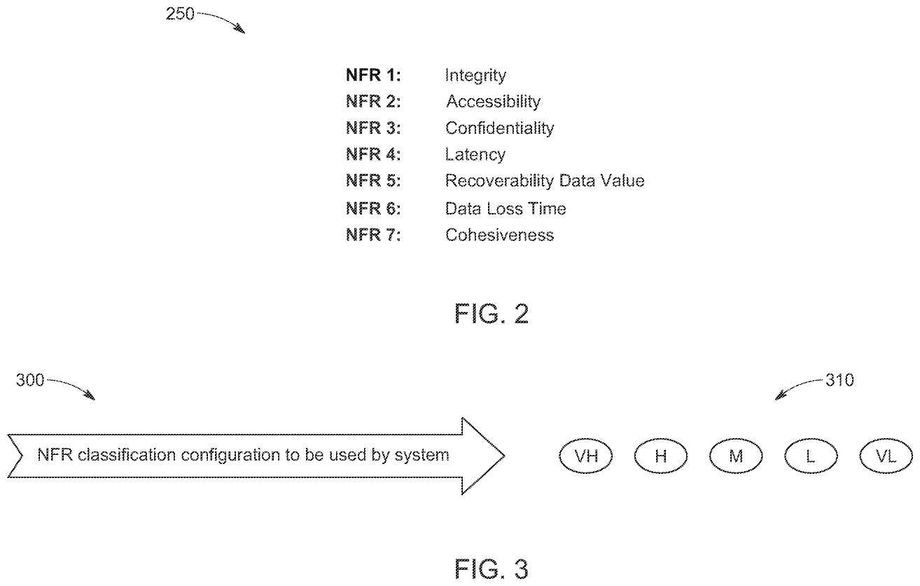

FIG. 2 illustrates example NFR classifications 250 that are business configured based on use-case specific requirements, according to one embodiment. As shown, the NFR classifications are as follows: NFR 1 is classified as integrity; NFR 2 is classified as accessibility; NFR 3 is classified as confidentiality; NFR 4 is classified as latency; NFR 5 is classified as recoverability data value; NFR 6 is classified as data loss time; and NFR 7 is classified as cohesiveness. In one embodiment, the NFR classifications are deemed as required based on the definition of such additive modifier parameter, pa (see, e.g., Eq. 1 below), such that it represents all the classifications required to create NFR based dispositions.

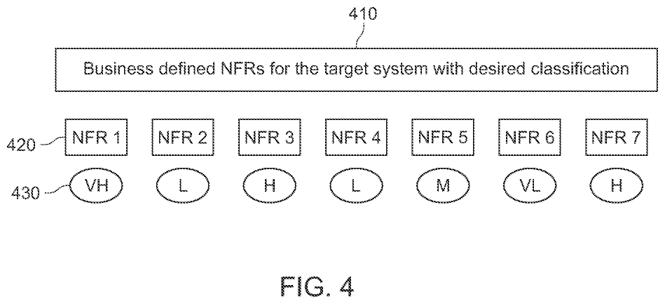

FIG. 3 illustrates example weightage 310 defined by business as a classification system with grading for the target system, according to one embodiment. The NFR classification configuration to be used by the system 300 uses weightage that is defined by business as a (penta-model) classification system, such as the example weightage 310 of very high (VH), high (H), medium (M), low (L), very low (VL) for the target system. This grading mechanism is used for grading the target systems as well.

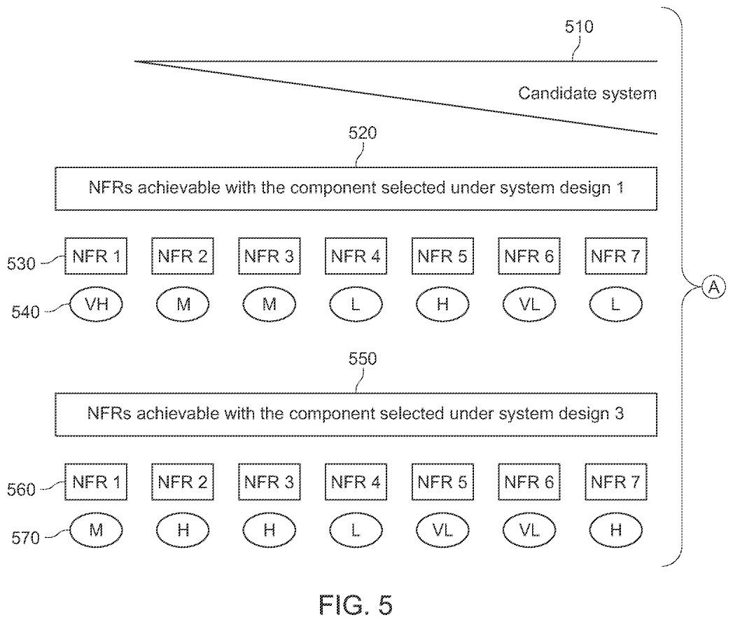

FIG. 4 illustrates an example of business defined NFRs for a target system with desired classification 410, according to one embodiment. Business prioritized its own disposition on these factors for the target system such as what is pertinent in terms of integrity? Is it high or medium? Business ranks this against all available classifications such as VH, H, M, L, VL. As shown, the NFRs 420 include NFR 1 to NFR 7. The available classifications 430 are associated with the NFRs 420. As shown, NFR 1 is classified as VH; NFR 2 is classified as L; NFR 3 is classified as H; NFR 4 is classified as L; NFR 5 is classified as M; NFR 6 is classified as VL; and NFR 7 is classified as H.

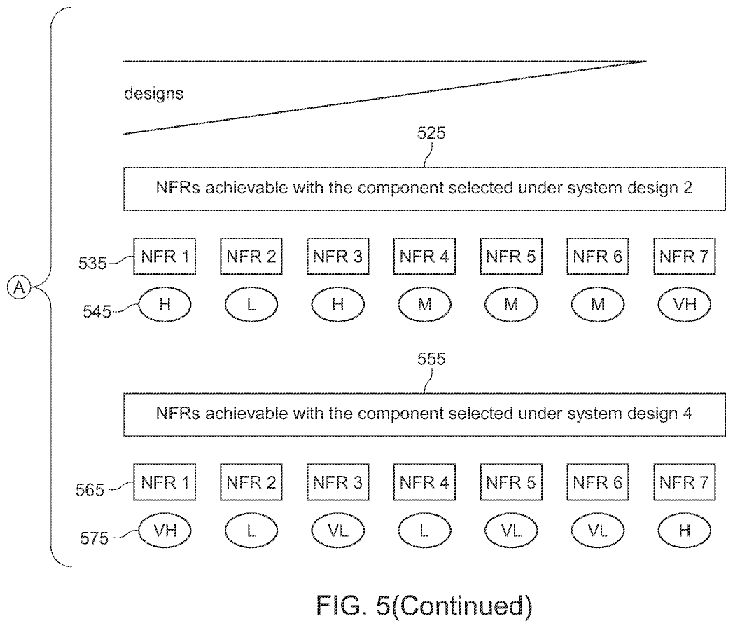

FIG. 5 illustrates an example of NFR classification for two systems each ranked against seven categories of NFR fulfilment for the combination of such attributes into heterogeneous links (System 1, System 2, System N) decided through an overall classification decision function, according to one embodiment. The candidate system designs 510 include NFRs that are achievable with the component selected under system design 1 520, NFRs that are achievable with the component selected under system design 2 525, NFRs that are achievable with the component selected under system design 3 550, and NFRs that are achievable with the component selected under system design 4 555.

System 1 includes NFRs (NFR 1 through NFR 7) 530 and associated classifications (VH, M, M, L, H, VL and L, respectively) 540. System 2 includes NFRs (NFR 1 through NFR 7) 535 and associated classifications (H, L, H, M, M, M and VH, respectively) 545. System 3 includes NFRs (NFR 1 through NFR 7) 560 and associated classifications (M, H, H, L, VL, VL and H, respectively) 570. System 4 includes NFRs (NFR 1 through NFR 7) 565 and associated classifications (VH, L, VL, L, VL, VL and H, respectively) 575.

In one embodiment, C is defined as the categories (features) of NFR fulfilment that will be an option to consider for the system. A framework for the combination of such attributes into heterogeneous links (System 1, System 2, System N) is decided through an overall classification decision function. In one or more embodiments, a request is considered with approximately known attributes and a target space granulated in categories. Properties of each attribute might suggest a different target value and the goal is to determine a combined target value and assign the request to a corresponding granule.

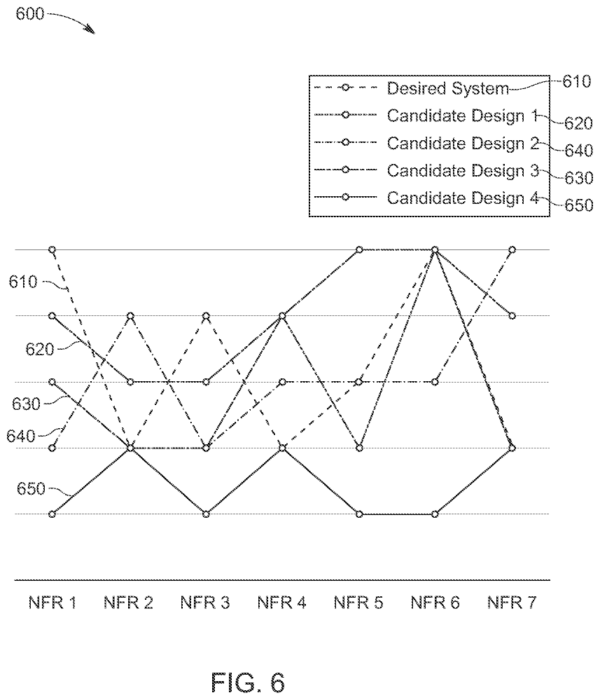

FIG. 6 illustrates a graph 600 of a desired system 610 and candidate systems (620, 630, 640 and 650) versus NFRs, according to an embodiment. In one embodiment, the target space (the significance level in classification) is normalized to a scale between [α, β] and the space is granulated. Target categories generally provide a granulation of the target space that is different from the input granulation. In one embodiment, let, a̅_̅{̅d̅}̅ be the value of a significance pointer that is assigned to an NFR token value due to properties of the attribute ‘d’. The values of a̅_̅{̅d̅}̅ are range-bound between [α, β] and they are accumulated by a decision function, which produces a combined significance measure for the request. The decision function [symbol] is defined as follows:

$${α , β}_{} = 1 - {\prod }_{d = 1}^{n} {( 1 - [ {p}_{d} - {m}_{d} . ] )}^{{w}_{d}} \qquad Eq . ( 1 )$$

where [symbol] _{α,β} is an accumulator decision function, and α,β are used as the interval limits that the significance measure is restricted to [α,β]. The decision function is built on three (3) free parameters, additive and multiplicative pointer modifiers pa and ma, respectively, and weights w_{d}. Because the significance measure is restricted to the interval [α,β], truncation is used by the addition of the parameter p_{d}, which is indicated in Eq. (1) by [p_{d}−m_{d}·a̅_̅{̅d̅}̅]. In one embodiment, the parameters are determined by a training operation on representative sets of objects with known classifications.

In one embodiment, the purpose of [symbol] training is to obtain such values of the function parameters p_{d}, m_{d}, and w_{d} such that the accumulated significance [symbol] is close to the correct target significance category Ĉ. Factors are introduced that are required to ensure that [symbol] provides unbiased decision for processing. The discord D between two (2) transposed sets (for attributes pertaining to the comparison within the systems) [symbol] and [symbol] , as,

$${D}_{{α , β}_{}} = 1 - {max}_{} {\{ {min}_{} [ \frac{\sum }{{n}_{1}} , \frac{\sum }{{n}_{2}} ] \}}_{⌊ α , β ⌋} \qquad Eq . ( 2 )$$

where [symbol] , is the transposed set of the significance category for n-features pertaining to the business target system, [symbol] is the transposed set of the significance category for n-features pertaining to the candidate system, and α,β are used as the interval that the significance measure is restricted to [α,β]. In one embodiment, C₁ denotes the business target system while C₂ denotes the candidate system.

In one embodiment, it is inferred that the discord varies between α and β and expresses the lack of intensity of coincidence between the two transformed sets. D [symbol] _{_{α,β}}→α is inferred when the cores of [symbol] and [symbol] intersect. D [symbol] _{_{α,β}}→β is inferred when support of [symbol] and [symbol] do not intersect. Then the next function is derived as an exclusion. The exclusion function ψ, is a measure for the lack of overlap of the membership functions for [symbol] and [symbol] .

$${ψ}_{α , β} = 1 - \frac{{\int }_{α}^{β} ( {min}_{} [ \frac{\sum }{{n}_{1}} . \frac{\sum }{{n}_{2}} ] ) . d}{{\int }_{α}^{β} \frac{\sum }{{n}_{2}} . d} \qquad Eq . ( 3 )$$

where [symbol] is the transposed set of the significance category for n-features pertaining to the business target system, [symbol] is the transposed set of the significance category for n-features pertaining to the candidate system, and α,β are used as the interval that the significance measure is restricted to [α,β].

In one embodiment, the canary-function & may then be computed from Eq. (2) and Eq. (3):

$${ξ}_{α , β} = {\{ \sqrt{\frac{[ {D}_{{α , β}_{}} + {ψ}_{α , β}^{2} ]}{2}} . [ \frac{\sum }{{n}_{1}} - \frac{\sum }{{n}_{2}} ] \}}_{[ - 1 , + 1 ]} \qquad Eq . ( 4 )$$

where α,β are used as the interval that the significance measure is restricted to [α,β], and −1, +1 are the envelope maxima and minima rules. Here, if ξ_{α,β}>0, then it is a best fit and is identified as the optimal fulfilment of the NFR requirements. If ξ_{α,β}≤0, then it is a canary exclusion and is targeted based on best fit (ψ_{α,β} and D [symbol] _{_{α,β}}).

One example embodiment of optimal fulfilment is as follows. A business asks for integrity as High and data loss as Low. The candidate system that provides integrity as High and data loss as Low (design consideration values towards the fulfillment of the NFRs) is computed by the framework as an optimal solution. Here, the canary function measure ξ_{α,β} is used as a similarity criterion for producing an expression of the classification result when each comparison within the systems is compared with significance categories. These categories are weighted and become a sorted vector (according to the grading value of each attribute) that is used to cover the entire solution space ordinally. The system now extrapolates the equations from Eq. (2) . . . . Eq. (4) to cover the entire solution space that is not restricted to bimodal canary. This can described as follows:

$${\{ {D}_{{α , β}_{}} = 1 - max {\{ min [ {\sum }_{t = 1}^{r} \frac{\sum }{{n}_{t}} ] \}}_{⌊ α , β ⌋} \}}_{r > 2} \qquad Eq . ( 5 )$$

where r is the range of the options in the sub-optimal space (should be at least two (2) and thus the decision is always pivotal as comparative values; note that the decision is provided individually for each candidate system), t is the candidate system index (the disclosed technology considers all the systems available in the sub-optimal space), the discord varies between the interval α and β and expresses the lack of intensity of coincidence between the two sets, D [symbol] _{_{α,β}} α when the cores of [symbol] intersect, and D [symbol] _{_{α,β}}→β when supports of [symbol] do not intersect.

In one embodiment, the second pass commences where the sub-optimal solution space is considered in absence of the optimal candidate system. The exclusion function is first derived. The exclusion function ψ is a measure for the lack of overlap of the membership functions for [symbol] and [symbol] as follows,

$${ψ}_{α , β} = 1 - {\{ \frac{{\int }_{α}^{β} ( min [ {\sum }_{t = 1}^{r} \frac{\sum }{{n}_{t}} ] ) . d}{{\int }_{α}^{β} {[ {\sum }_{t = 1}^{r} \frac{\sum }{{n}_{t}} ]}_{⌊ α , β ⌋} . d} \}}_{r > 2} \qquad Eq . ( 6 )$$

where r is the range of the options in the sub-optimal space (should be at least two (2) and thus the decision is always pivotal as comparative values (note that the decision is provided individually for each candidate system), t is the candidate system index (the disclosed technology considers all the systems available in the sub-optimal space).

In one embodiment, next the canary-function & may be computed as,

$${ξ}_{α , β} = {\{ \sqrt{\frac{[ {D}_{{α , β}_{2}^{}} + {ψ}_{α , β}^{2} ]}{2}} . [ {\sum }_{t = 1}^{r} [ \frac{\sum }{{n}_{t}} - \frac{\sum }{{n}_{t - 1}} ] ] \}}_{[ - 1 , + 1 ]} \qquad Eq . ( 7 )$$

where α,β are used as the interval that the significance measure is restricted to [α,β], −1, +1 are the envelope maxima and minima rules, r is the range of the options in the sub-optimal space (should be at least two (2) and thus the decision is always pivotal as comparative values; (should be at least two (2) and thus the decision is always pivotal as comparative values; note that the decision is provided individually for each candidate system), t is the candidate system index (the disclosed technology considers all the systems available in the sub-optimal space), if ξ_{α,β}>0, then it is best fit and is identified as the optimal fulfilment of the NFR requirements, and if ξ_{α,β}≤0, then it is a canary exclusion and is targeted based on best fit (ψ_{α,β} and D [symbol] _{_{α,β}}).

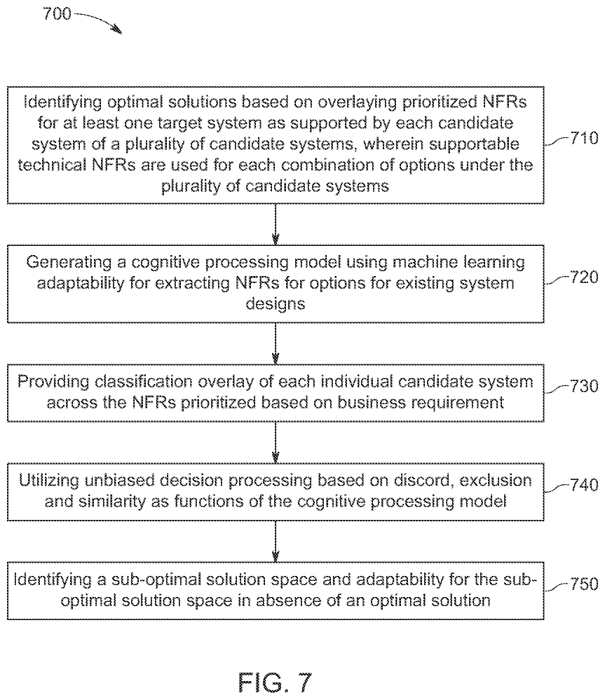

FIG. 7 illustrates a process 700 for providing NFR fulfilment based technical disposition, according to an embodiment. In one embodiment, in block 710 process 700 performs identifying optimal solutions based on overlaying prioritized NFRs for at least one target system as supported by each candidate system of multiple candidate systems. In one embodiment, supportable technical NFRs are used for each combination of options under the multiple candidate systems. In block 720, process 700 generates a cognitive processing model using machine learning adaptability for extracting NFRs for options for existing system designs. In block 730, process 700 provides classification overlay of each individual candidate system across the NFRs prioritized based on business requirement. In block 740, process 700 utilizes unbiased decision processing based on discord, exclusion and similarity as functions of the cognitive processing model. In block 750, process 700 identifies a sub-optimal solution space and adaptability for the sub-optimal solution space in absence of an optimal solution.

In some embodiments, process 700 may include the feature where the unbiased decision processing utilizes a decision function based on additive and multiplicative pointer modifiers and weights.

In one or more embodiments, process 700 may further include the feature that the additive pointer modifier represents all classifications required to create NFR based dispositions.

In some embodiments, process 700 may include the feature where the additive and multiplicative pointer modifiers and weights are determined by a training operation on representative sets of objects with known classifications.

In one or more embodiments, process 700 may additionally include the feature that an NFR classification configuration utilized by a candidate system uses weightage that is defined by business as a penta-model classification system.

In some embodiments, process 700 may further include the feature that a second processing iteration for the identifying optimal solutions commences where the sub-optimal solution space is considered in absence of the optimal candidate system.

In one or more embodiments, process 700 may include the feature that a canary function measure is used as a similarity criterion for producing an expression of a classification result when each comparison within the classification systems is compared with significance categories, and the significance categories are weighted and become a sorted vector that is utilized to cover an entire solution space ordinally.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

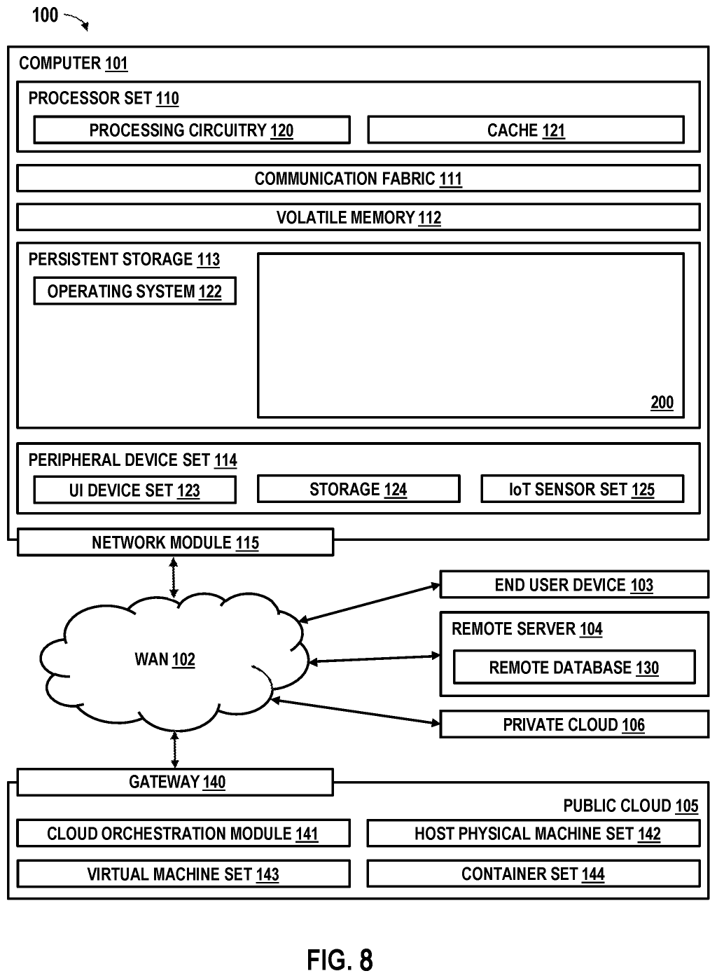

FIG. 8 illustrates an example computing environment 100 utilized by one or more embodiments. Computing environment 100 contains an example of an environment for the execution of at least some of the computer code involved in performing the inventive methods, such NFR fulfilment based technical disposition code, cognitive processing model code using machine learning code, cognitive processing model code, etc.) 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the embodiments for various embodiments with various modifications as are suited to the particular use contemplated.

What is claimed is:

1. A method of using a computing device to provide non-functional requirement (NFR) fulfilment based technical disposition, the method comprising:
identifying optimal solutions based on overlaying prioritized NFRs for at least one target system as supported by each candidate system of a plurality of candidate systems, wherein supportable technical NFRs are used for each combination of options under the plurality of candidate systems, the identifying further including:
generating a cognitive processing model using machine learning adaptability for extracting NFRs for options for existing system designs;
providing classification overlay of each individual candidate system across the NFRs prioritized based on business requirement; and
utilizing unbiased decision processing based on discord, exclusion and similarity as functions of the cognitive processing model; and
identifying a sub-optimal solution space and adaptability for the sub-optimal solution space in absence of an optimal solution.

2. The method of claim 1, wherein the unbiased decision processing utilizes a decision function based on additive and multiplicative pointer modifiers and weights.

3. The method of claim 2, wherein the additive pointer modifier represents all classifications required to create NFR based dispositions.

4. The method of claim 2, wherein the additive and multiplicative pointer modifiers and weights are determined by a training operation on representative sets of objects with known classifications.

5. The method of claim 1, wherein an NFR classification configuration utilized by a candidate system uses weightage that is defined by business as a penta-model classification system.

6. The method of claim 1, wherein a second processing iteration for the identifying optimal solutions commences where the sub-optimal solution space is considered in absence of the optimal candidate system.

7. The method of claim 1, wherein a canary function measure is used as a similarity criterion for producing an expression of a classification result when each comparison within the classification systems is compared with significance categories, and the significance categories are weighted and become a sorted vector that is utilized to cover an entire solution space ordinally.

8. A computer program product for providing non-functional requirement (NFR) fulfilment based technical disposition, the computer program product comprising a computer readable storage medium having program instructions embodied therewith, the program instructions executable by a processor to cause the processor to:
identify, by the processor, optimal solutions based on overlaying prioritized NFRs for at least one target system as supported by each candidate system of a plurality of candidate systems, wherein supportable technical NFRs are used for each combination of options under the plurality of candidate systems, the identifying further including:
generate, by the processor, a cognitive processing model using machine learning adaptability for extracting NFRs for options for existing system designs;
provide, by the processor, classification overlay of each individual candidate system across the NFRs prioritized based on business requirement; and
utilize, by the processor, unbiased decision processing based on discord, exclusion and similarity as functions of the cognitive processing model; and
identify, by the processor, a sub-optimal solution space and adaptability for the sub-optimal solution space in absence of an optimal solution.

9. The computer program product of claim 8, wherein the unbiased decision processing utilizes a decision function based on additive and multiplicative pointer modifiers and weights.

10. The computer program product of claim 9, wherein the additive pointer modifier represents all classifications required to create NFR based dispositions.

11. The computer program product of claim 9, wherein the additive and multiplicative pointer modifiers and weights are determined by a training operation on representative sets of objects with known classifications.

12. The computer program product of claim 8, wherein an NFR classification configuration utilized by a candidate system uses weightage that is defined by business as a penta-model classification system.

13. The computer program product of claim 8, wherein a second processing iteration for the identifying optimal solutions commences where the sub-optimal solution space is considered in absence of the optimal candidate system.

14. The computer program product of claim 8, wherein a canary function measure is used as a similarity criterion for producing an expression of a classification result when each comparison within the classification systems is compared with significance categories, and the significance categories are weighted and become a sorted vector that is utilized to cover an entire solution space ordinally.

15. An apparatus comprising:
a memory configured to store instructions; and
a processor configured to execute the instructions to:
identify optimal solutions based on overlaying prioritized NFRs for at least one target system as supported by each candidate system of a plurality of candidate systems, wherein supportable technical NFRs are used for each combination of options under the plurality of candidate systems, the identifying further including:
generate a cognitive processing model using machine learning adaptability for extracting NFRs for options for existing system designs;
provide classification overlay of each individual candidate system across the NFRs prioritized based on business requirement; and
utilize unbiased decision processing based on discord, exclusion and similarity as functions of the cognitive processing model; and
identify a sub-optimal solution space and adaptability for the sub-optimal solution space in absence of an optimal solution.

16. The apparatus of claim 15, wherein the unbiased decision processing utilizes a decision function based on additive and multiplicative pointer modifiers and weights.

17. The apparatus of claim 16, wherein the additive pointer modifier represents all classifications required to create NFR based dispositions.

18. The apparatus of claim 16, wherein the additive and multiplicative pointer modifiers and weights are determined by a training operation on representative sets of objects with known classifications.

19. The apparatus of claim 15, wherein:
an NFR classification configuration utilized by a candidate system uses weightage that is defined by business as a penta-model classification system; and
a second processing iteration for the identifying optimal solutions commences where the sub-optimal solution space is considered in absence of the optimal candidate system.

20. The apparatus of claim 15, wherein a canary function measure is used as a similarity criterion for producing an expression of a classification result when each comparison within the classification systems is compared with significance categories, and the significance categories are weighted and become a sorted vector that is utilized to cover an entire solution space ordinally.
